(19) United States
(12) Patent Application Publication
(10) Pub. No.: US 2009/0327100 A1
(43) Pub. Date: Dec. 31, 2009

(54) Method of Internet Video Access and Management

(75) Inventors: Jonathan Greenberg, Sebastopol, CA (US); David Ekhaus, San Francisco, CA (US)

Correspondence Address: EDWARD S. SHERMAN, ESQ., 3554 ROUND BARN BLVD., SUITE 303, SANTA ROSA, CA, 95403, US

(73) Assignee: TV1.com Holdings, LLC, Sebastopol, CA (US)

(21) Appl. No.: 12/493,248

(22) Filed: Jun. 29, 2009

Related U.S. Application Data
(60) Provisional application No. 61/076,688, filed on Jun. 29, 2008.

(51) Int. Cl. G06Q 30/00; G06F 17/30; G06F 3/048

(52) U.S. Cl. 705/27; 707/102; 715/720; 715/835

(57) ABSTRACT

A system and apparatus for enabling the end user to schedule the display of online videos and dynamically displaying online videos according to a user preference. The system provides an editorially-selected guide to online videos in which videos from existing online video providers are gathered under a single portal and thereby provides the end user a directory through which the user can view recommended videos as presented by the system, or personalize the selections into a dynamically-generated subset of videos. The system also provides a seamless playlist of multiple videos from various websites, and allows the user to manage and re-sequence this playlist.

### CROSS REFERENCE TO RELATED APPLICATIONS

The present application claims priority to the US provisional application having Ser. No. 61/076,688 of the same title, that was filed on Jun. 29, 2008, which is incorporated herein by reference

### BACKGROUND OF INVENTION

The present invention relates to the selection and display of video available on the Internet

The Internet has in the last several years become a popular means for distributing and viewing video content from a wide variety of media sources, as well as user generated video content.

However, this popularity also creates the dilemma for the end users that do not have enough free time to browse all the available Internet video resources for content of interest, such as news, entertainment, educational media and the like.

Accordingly, it is an object of the invention to provide such end users with an improved means to access quality video media of interest on the Internet.

### SUMMARY OF INVENTION

Generally speaking, the invention relates to innovative techniques to generate a directory of videos from existing online digital videos whereby the end user is enabled to aggregate videos that are selected by editors from multiple web video websites

The end user can specify preferences and the system dynamically generates a listing subset of editor-selected videos that satisfy these preferences. From that listing the videos can be selected and scheduled for play by the end user. A second aspect of the invention is that videos are selected and scheduled for play according to the user's individual preference to enable the end user to sequentially watch the end product of the scheduling-the individualized program-in an automatic “playlist” fashion which forgoes the problem of having to travel to various websites or search for a new video to see more than one web video. A third aspect of the invention is that videos are selected to add to a user's library or database of stored references, which can reside on a remote server that hosts the editor selected videos, on the user's computer or another computer or server.

Another inventive aspect is the system displays the total length of the program, comprised of various web videos from the website that are selected and sequenced by the end user.

Another aspect of the invention is achieved by providing a method of Internet video content management comprising obtaining a plurality of URL's that provides video content, viewing the video content of the URL's, selecting a portion of the URL's to recommend for access by others in the form of a playlist, characterizing the video content of the playlist by attributes of, which include: a name associated with the party that made the selection in the previous step, a category, and the total play time, and then storing the URLs of the video content and the attributes in a data structure that is computer readable.

A further aspect of the invention is a method of viewing video content on a connected network of servers comprising the steps of defining user preferences to form a customer menu that comprises categories of content, providing an end-user with a GUI in which a matrix of potential videos is presented organized by the categories of content, selecting potential videos in the GUI to form a playlist for the sequential play of the selected videos, initiating the play of the playlist by the end-user via a web browser on a media device in signal communication with the network, wherein said step of initiating play causes the further steps of acquiring a series of URL's to form a view script in accordance with the playlist, the view script comprising the series of URL's and playtimes for each URL, wherein the view script is operative for directing the end-user web browser to the first URL in the selected series in the play list for a first predetermined amount of time, and then directing the end-user web browser to at least one subsequent URL in the view list after the previous predetermined playtime for the subsequent predetermined playtime.

Yet still another aspect of the invention is a graphic user interface (GUI) for viewing a collection of videos that comprises a matrix of potential videos organized by categories of content, wherein 2 or more choices are presented in each category portion of the matrix, each element in the matrix including at least one of: a sample video frame, a title and a play time, wherein the GUI is operative to develop and display a playlist for the content by the selection of matrix elements using icons with the element.

Still another aspect of the invention is a graphic user interface (GUI) for viewing an interactive video editorial created by a human agent, the GUI comprising a plurality of icons, each icon representing a different video available for play in the substantially complete sequence from a hosting server by designating a URL, a first viewing frame for viewing any of the videos represented by said plurality of icons, a control icon operative to view a video comprising portion of each of the videos in the plurality interspersed with commentary thereof between each of the portions in the first viewing frame, wherein selecting one of the plurality of icons cause the video so selected to be viewed in the first viewing frame.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1 is a schematic view of a first Graphic User Interface (GUI) for creating a video playlist.

FIG. 2A is a flow chart showing the process for video characterization used to select videos for potential inclusion in the GUI of FIG. 1.

FIG. 2B is a flow chart for the process of using the GUI of FIG. 1 to create a selective playlist of videos that are characterized according to the process of FIG. 2A.

FIG. 3 is a flow chart for the process of the playlist execution.

FIG. 4 is a flow chart for an alternative embodiment of the process of playlist execution.

FIG. 5 illustrates one embodiment for the derivation of the fingerprint marker data from a video that is optionally used in the process of FIG. 4.

FIG. 6 is a second GUI for editing the video playlist of FIG. 1.

FIG. 7 is another GUI for viewing a interactive video editorial

FIG. 8 is a different time segment of the view of the GUI in FIG. 7.

FIG. 9 is an alternative view selective from the GUI of FIG. 7 or 8 as an editable playlist

FIG. 10 is a GUI for adding video content to the editable playlist of FIG. 9

FIG. 11 is a GUI for saving the editable playlist of FIG. 9 or FIG. 10

FIG. 12 in a GUI for sharing the editable playlist of FIG. 9 or FIG. 10 with another party.

FIG. 13 is a GUI for commenting on the interactive video editorial accessed with the GUI's in FIG. 7-12.

### DETAILED DESCRIPTION

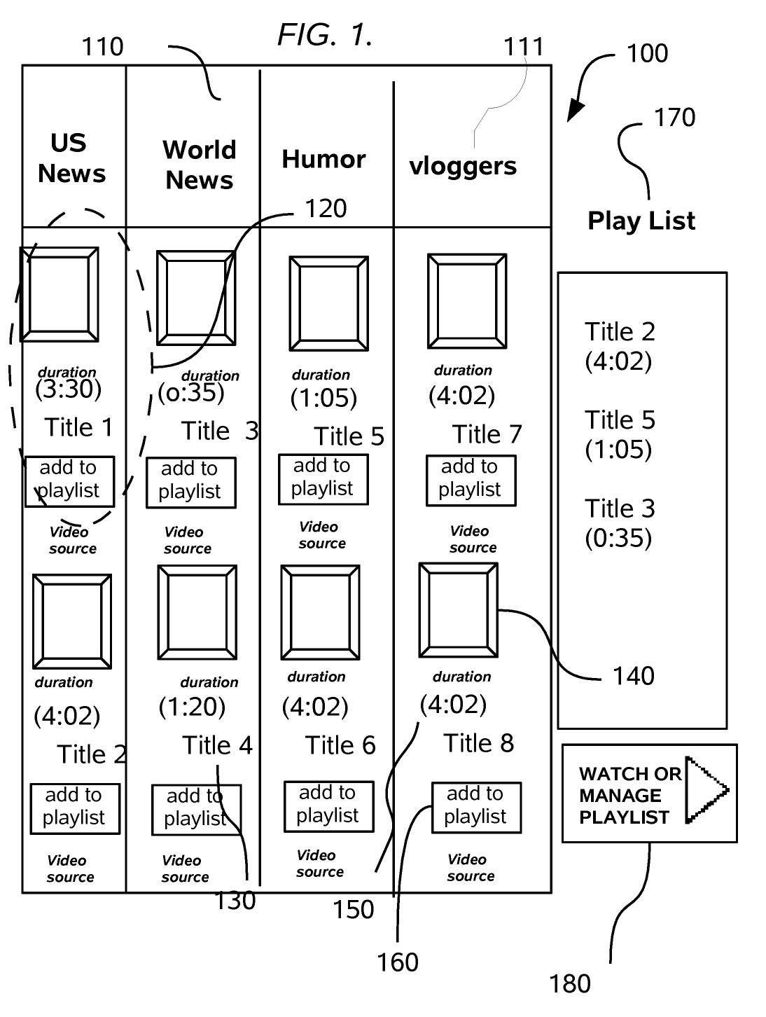

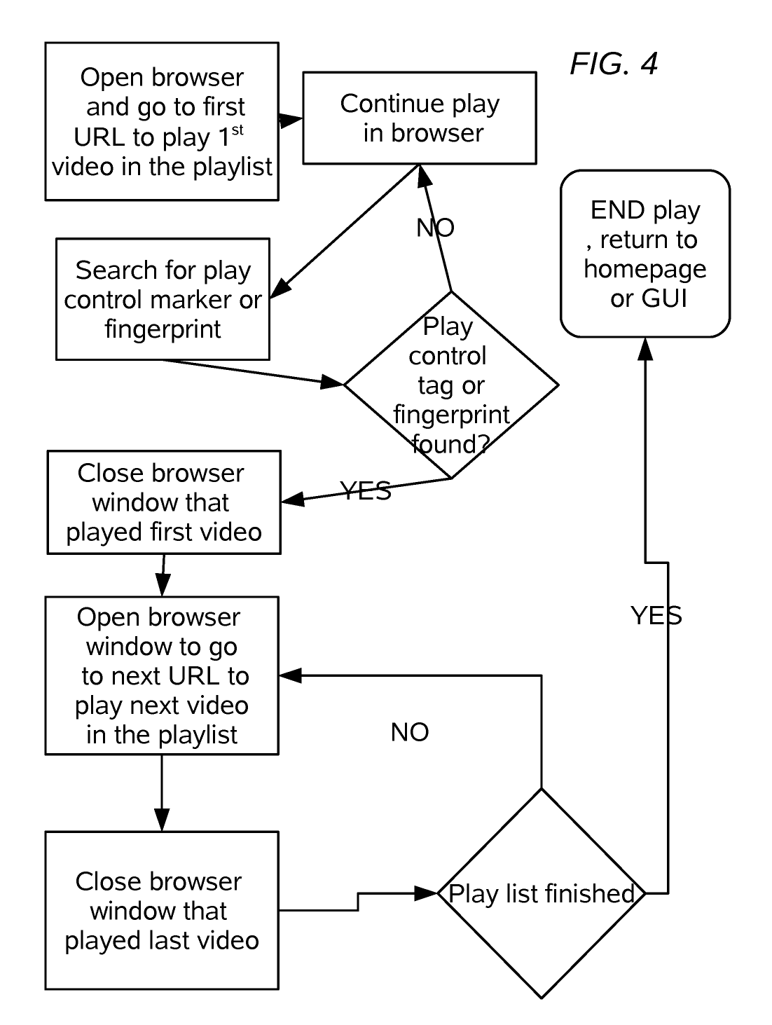

Referring to FIGS. 1 through 13 wherein like reference numerals refer to like components in the various views, there is illustrated therein a new and improved Method of Internet Video Access and Management.

The inventors have come to appreciate that it would be of great benefit to end-users, which is consumers of web video media, to provide a means to view quality content of interest when and where they wanted, including through wired or wireless connection to the Internet, for display over computer screens, TV screens, mobile phones and the like.

Accordingly, it is a first object of the invention to provide a means for users to have an editorially-selected guide for high quality web video content viewable at times controlled by the user.

While it would be possible, at least in theory, to acquire the right to re-play or broadcast Internet video from multiple websites on a single site, this is not practical for several means. One is the dynamic nature of the Internet, and the proliferation of sites featuring news and entertainment. The other is the sheer size of the available material that is dispersed around the world on various servers. Thus, the time and effort involved to negotiate and acquire rights to such content, and then transfer it to a single server or source for play would be inconvenient and unlikely to readily provide as much content as viewers could obtain by going directly to the servers originally hosting the video materials.

Thus, the inventors have come to further appreciate that it is preferable to provide an improved means for end users to find, select and play a variety of editorially-selected, high quality web video that suits their tastes and interests using the native websites that feature such video, therefore avoiding the needs to acquire rights for replay as well as the need to aggregate the media to a single server or service center.

The inventors have also come to appreciate that such an improved means preferably provides end-users with options so that they can make intelligent choices of what to view rapidly, without the need to “cruise” to multiple sites.

The inventors have also come to appreciate that such an improved means preferably provides end-users with the ability to play their selection from the multiple intelligent choices with minimum manual action after such choice is made.

Thus, in accordance with the above discoveries of the problems and needs of users of Internet media there is disclosed herein various embodiments of inventive methods, data structures, and graphic user interfaces that resolves the problem of piecing together multiple web videos from various sites by allowing the user to create and then play a personalized program of these videos to provide a new and improved system for organizing, viewing, storing and sharing web videos.

The inventive method incorporates the dynamic displaying of videos of a specific preference. The system deploying this method operates such that when a specific script indicating a specific content is activated, a metadata of online videos selected through a human editorial processing sifts only videos pertaining to the given content and presents them to the user. The presentation involves a hyperlink-based object locator that is linked to the relevant video from the existing hosting platform, and the metadata comprises of multiple relevant existing hosting platforms.

The system incorporates an online sequential playing of videos from different existing online videos hosts. It enables the user to mix videos from different video hosting platforms. The mixing refers to the capability to combine different videos and put them on a single stream script that displays one video after another in sequence. A deployment of the method involves an interface through which the end user has access to a means for organizing the sequence in which videos are displayed. The process preferably operates entirely online. Other aspects of the invention includes the ability to create other video playlists as well, using diverse sources such as video files on their computer, another computer or servers by storing the URL associated with the stored videos as videos links. The user can optionally upload additional videos to a computer server, and create playlists and along with video commentary on other videos (such as “Vlogs” defined further below), thus creating the user's personal library of stored references, as a database for future retrieval by that user, or for providing access or a custom playlist of selected videos for transmittal to others. The library can contain or provide access to individual videos, URL's for videos and playlists of videos. Various aspects of the present invention improve on existing technology by providing a single portal in which the meta-database associated with existing videos hosted on a plethora of independently run and sponsored websites are combined and generated for the end user to select, choose, and program the online videos according to the individual preference, functioning entirely online. Other aspects of the present invention also involves a human editorial processing of videos by which the online videos to be included in the system are selected.

In a preferred embodiment, end users deploy a standard web browser program on a general purpose computer connected to the Internet or a similar WAN or LAN, to create a playlist. The playlist 170 is simply a sequential order of selected video in which they are to be played. While other websites offer such playlists, they do so using the content available directly from the same website. In the instant invention, the playlist 170 is created from a menu displayed in a graphic user interface (GUI) 100, such as that shown in FIG. 1. This GUI 100 presents video from multiple websites, to enable the sequential play thereof, without the end user needing to personally redirect the browser between the sites hosting each of the videos selected. Preferably, this GUI 100 is presented as a matrix in which the videos of potential of interest are presented as a series of columns 110. The columns 110 are arranged by categories of subject matter, as listed at the top of each column. Alternatively, the presentation can be rotated 90 degrees, with the categories arranged in rows. Each column then has multiple entries 120 beneath the column heading which is in the first row of the matrix. Each entry 120, containing a small “thumbnail” image of that entry 140, represents a video that can be played. The information in the entry 120, as well as the column category it is assigned to, helps the user decide which video to add to the play list 170. Such entries 120 preferably, but without excluding of other information, may include a title 130 and the play time 150. Additional descriptive information may appear when a cursor is placed over a video. The entry 120 may optionally includes rating information, such as the quality rating assigned by a human reviewer, the number of times watched or played by others, a family suitability rating, the source of the video, the author or contributor, and the like. Each entry 120 further includes a control interface 160 that when activated, such as by clicking, adds the video associated with the entry 120 to the play list 170. The playlist 170 is thus dynamically selected by the end-user and displayed at the side, but is also optionally display at top or bottom of the matrix.

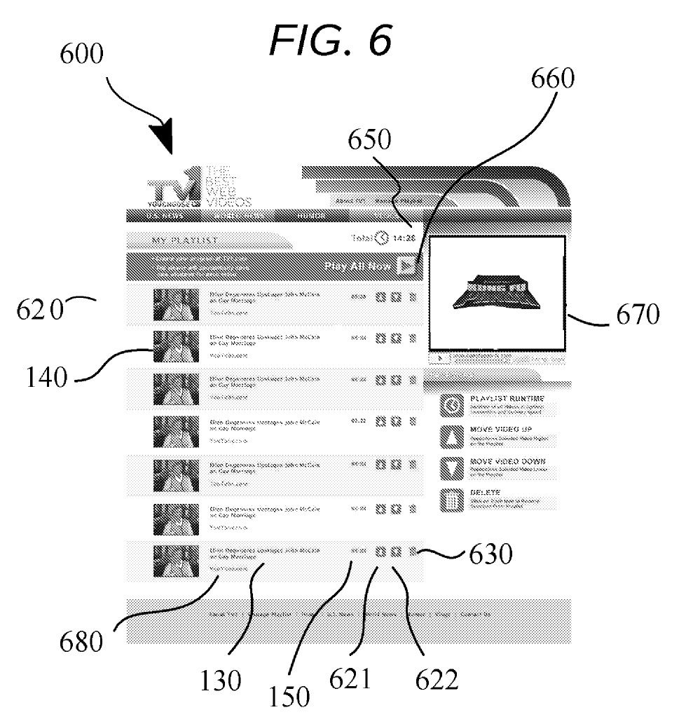

Execution of the playlist can be activated on the GUI 100, through one or more play buttons controls, but preferably as shown a control 180 opens another GUI 600, shown in FIG. 6 that enable the users to both manage the playlist as well as execute it to cause the sequential of each video in the playlist. When the play button is activated, either from GUI 100 or GUI 600, the further execution of the sequential play is automatic. The play button activation then generates a script that directs the end-users web browsers to the URL for the sequence of video in the playlist. The transition from one video to another can be seamless and does not require the end user's inputs. Alternatively, the playlist can execute one video at time in which the user activates an icon to play the next video in the playlist sequence.

The matrix of the GUI 100 in FIG. 1 arises from selection by human editors from thousands of potential websites, with regular updating.

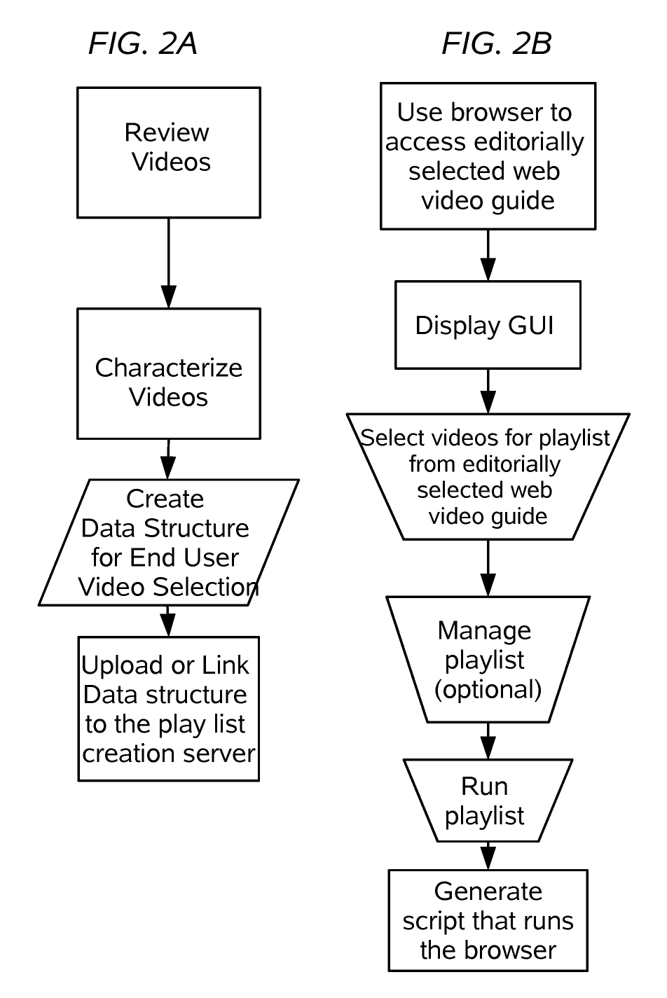

It should be appreciated that some process of selection needs to occur to create the GUI 100 The flow chart in FIG. 2A illustrates the process of charactering video media to enable the generation of the GUI 100 in FIG. 1. In the first step of the process, web videos freely available on the Internet are viewed. The human editor then characterizes the video by either automatically or manually recording at least the information to be placed in each entry 120 in the GUI 100. These recorded characteristics are entered into a data structure that is computer readable such that the GUI 100 draws the information presented in the matrix from the data structure.

Such video attributes subject to characterization and storage in this data structure are akin to and may include any known or future developed form meta-data provided by the native hosting sites, as well as any information the human editors deem useful to end-users in making the playlist selections.

The GUI 100, whether standard or customized, thus enables another aspect of the inventive method by effectively aggregating content through which the web browser serves as a stream script to show a combination of videos.

The characterization generally includes at the least the time and subject title, but may include other characteristics, such as short descriptions, categories, the reviewer's name, or the reviewers rating of the content. The first server that displays the GUI 100 also contains or is linked to the data structure that contains the URL that will direct the browser to other servers that hosts the video. Such a data structure would also contain in association with each video URL at least a title, anticipated play time and at least one still image frame 140 from the video, as well as any other characterization the editor/viewer deems helpful to enable the end users selection from the GUI 100.

The characterization in the data structure is used to place the video frame 140 and associated data in the correct subject column in the GUI of FIG. 1. The characterization can also include a sub-characterization into sequential segments that feature different subjects. For example, an ordinary news broadcasts usually discusses world and national news, local news, sport and assorted human interest stories. It would be valuable to characterize such a video by the time length of each such segment, as this would allow the placement of different segments in different content categories or columns. The GUI 100 provides the end user with sufficient current information to build a custom play list, in effect creating their unique news/entertainment program for the desired length of time.

Accordingly, GUI 100 will include sufficient information that enables a thoughtful choice by each end-user within the categories of interest. Further, it would also be advantageous to also characterize such videos by noting contextual and sequence control markers to aid in the sequential replay of segments found at different web sites.

The present method uses a script software program that combines multiple videos from various serving locations into a seamless program, and allows them to be played back to back without interruption.

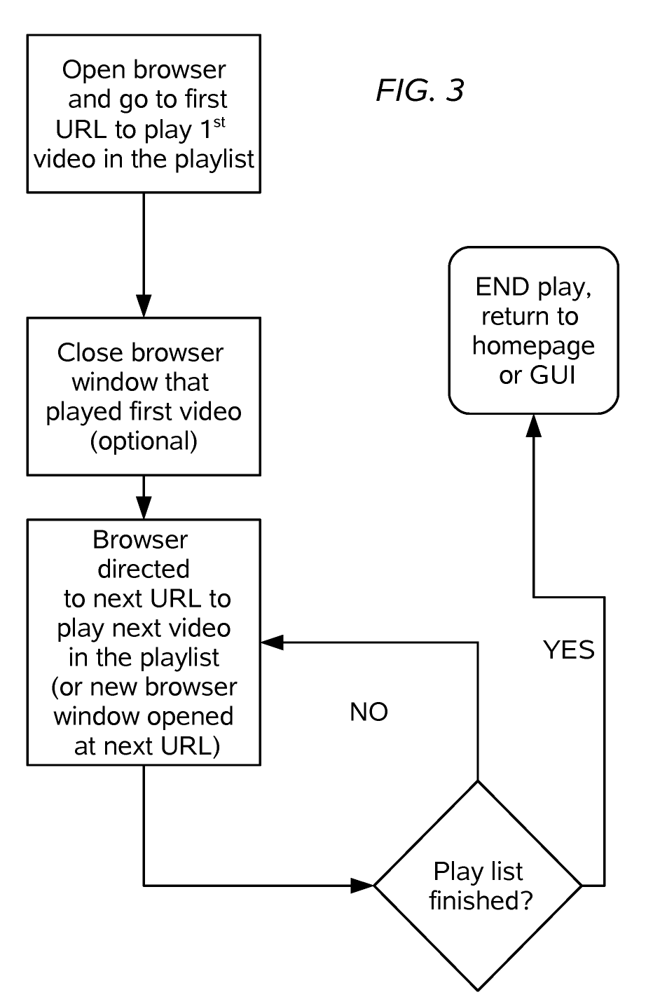

As shown in the flow chart of FIG. 3, when the playlist is run the server hosting the GUI 100 generates a program in the form of a script, such as JavaScript, that is operative to control the user's browser program to access the URL's that direct the browser to the web sites hosting the videos in the playlist. The script contains not only the URL, but the play time of the video as a characteristic. The browser is preferably directed by the script to close the window and go to a subsequent URL in the playlist after the prior play time is reached.

It has been discovered that although a video may have a visible play length that is relatively constant to end-users at different locations or times of day, the actual time that the browser will need to be open at the URL hosting the video, i.e. the displaying server, can vary considerably, depending on the user's connection speed or bit rate, a website's web video serving speed, and the unpredictable inclusion of other material (such as advertising) that could be added from time to time to the beginning or the end of the video segment. To the extent that the time of each video varies from the initial characterization multiple browser windows may be open simultaneously.

If the first or any preceding video takes longer than the playtime 150 characteristic shown in entry 120 of the GUI 100 and stored in the data structure, as for example because it requires more time to fill the video data buffer before the video can play, then this video window would close before the entire video content is played for the end-user. This could result in the simultaneous opening of the next browser window to show the subsequent video in the playlist. Thus, a viewer might miss the beginning of the next video while they are viewing the end of the previous video. Alternatively, if it plays faster, the end-user may need to wait until the script causes the next video in the playlist sequence to open. If these overlaps or delays are too frequent or too long, the end-user may become frustrated and not enjoy what is intended to be a seamless viewing experience.

Hence, it is more preferable in another embodiment of the invention that the script generated by activation of the play button in GUI 100, or another program, such as a native program running on the computer or via a plug in program to the browser, be operative to monitor the progress of each video before it opens the next window. If the selected video has ended faster than predicted, the script, or alternative program, preferably directs the browser to the URL of the next playlist entry. If the video has not ended in the time length predicted the script delays directing the browser to the next URL.

One mode of such a control embodiment described above can be based on providers of video content, the native sites, to provide embedded markers that can be “read” by the browser or other program, but would not be visible or audible to the end-users, unless so desired. The marker characterization would be part of the characterization process in FIG. 2A, and be added to the data structure that generates the entries into the GUI 100 and the control script associated with the play function. The script would be operative to sequence the opening and closing of new browser windows, as well as the desktop placement thereof, in accord with identifying these markers as the video is played to the end-user.

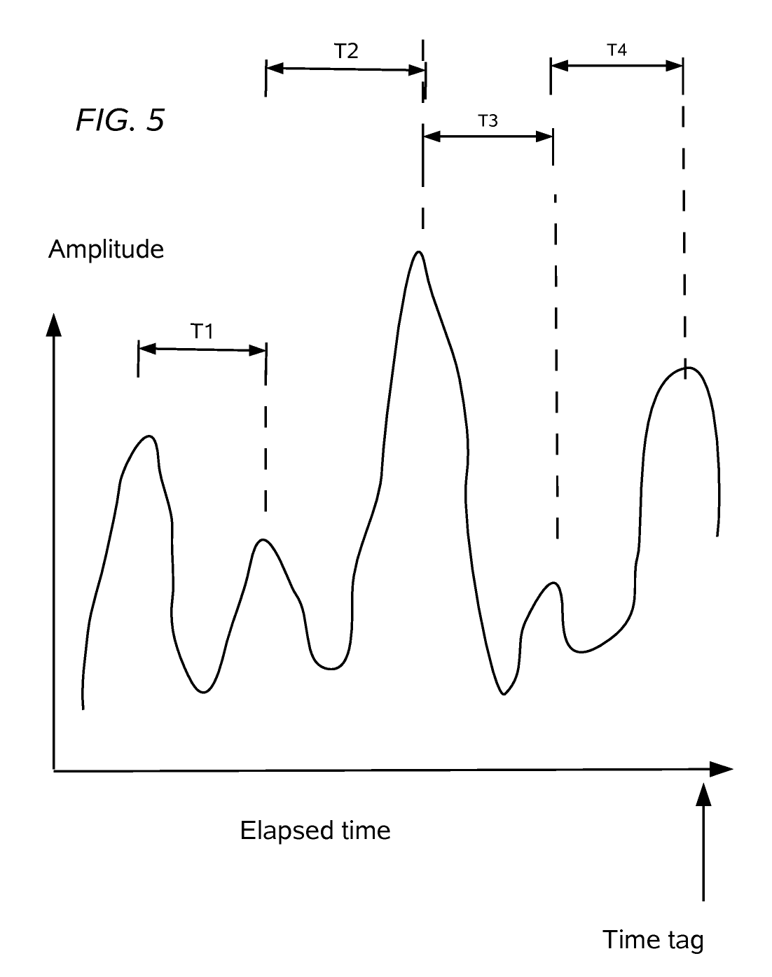

Absent, the video host sites providing such markers, an alternative embodiment of the invention is that the characterization step in FIG. 2A include the identification of unique attributes with the image and/or audio data of the video contained can be continuously tracked by the browser, script, native program or plug in. For example, the audio track of the video, which can be monitored as the video is played, can be characterized at the video portion of interest by a sound amplitude fingerprint described below with the aid of FIG. 5 Such fingerprints might simply be the time sequence between successive peaks and valley in amplitude at the play time the editor desires to “mark”. Thus in FIG. 5, in which the amplitude of sound is plotted on the ordinate and the time is plotted on the abscissa, such a sequence of time is represented by vertical bars labeled T1, T2, T3 and T4, the value of each being the time difference between the successive peaks in amplitude that the bar extends between. Thus, the script generated from the selections in the GUI 100 could also direct an application program interface to continuously monitor for the same fingerprint while the video is played. If the fingerprint is found then the browser can close the current window and go on to the next URL in the playlist.

Thus, such fingerprints and markers can be generated and associated with the beginning and end of the video of interest, with at least one or both characteristics being used to sequence the opening and closing of browser windows at the different URL to create a seamless viewing experience one the end user initiate the operation of play from the play list, even though multiple servers are accessed. For example, a fingerprint marker at the beginning of the video segment of interest could be used to move the window showing the video to the top of the window stack on the user's computer screen desktop. The fingerprint marker at the end of the video would be used to go to the next URL in the playlist associated script.

Other means of creating such fingerprint markers include characterizing specific pixel data in the video feed itself. That is, one combination of pixels of sufficient length is selected so that it has data unique to the first time tag and another combination of pixels of sufficient length is selected so that it has data unique to the next or last time tag. The pixel data preferably comes from a signal frame, but may include reference to more frame. As video compression techniques transmit the relative changes in portion of the pixel map, automated processing of the video image stream can be used to select the unique pixel data points. Thus, another sub-process in the characterization step of FIG. 2A is selecting the fingerprint, be it from audio or pixel image data, and more preferably verify its uniqueness within the video to correspond with the time segments the editor wishes to mark.

In another embodiment of the invention there is a method that deploys an automatic system in which once the end user sets a preference for the display of the GUI 100, which becomes a personalized page containing desirable videos for that end user that can be accessed through the system. Summaries of this personalized page could be delivered periodically to users through e-mail. Such preference might be in various embodiments the categories they wish to select from, as for example, and the end user might want their custom GUI to also offer a choice of news about a particle country, or reviews and/or news about a specific types of entertainment, for example movie review or short trailers of new movies released in the last month.

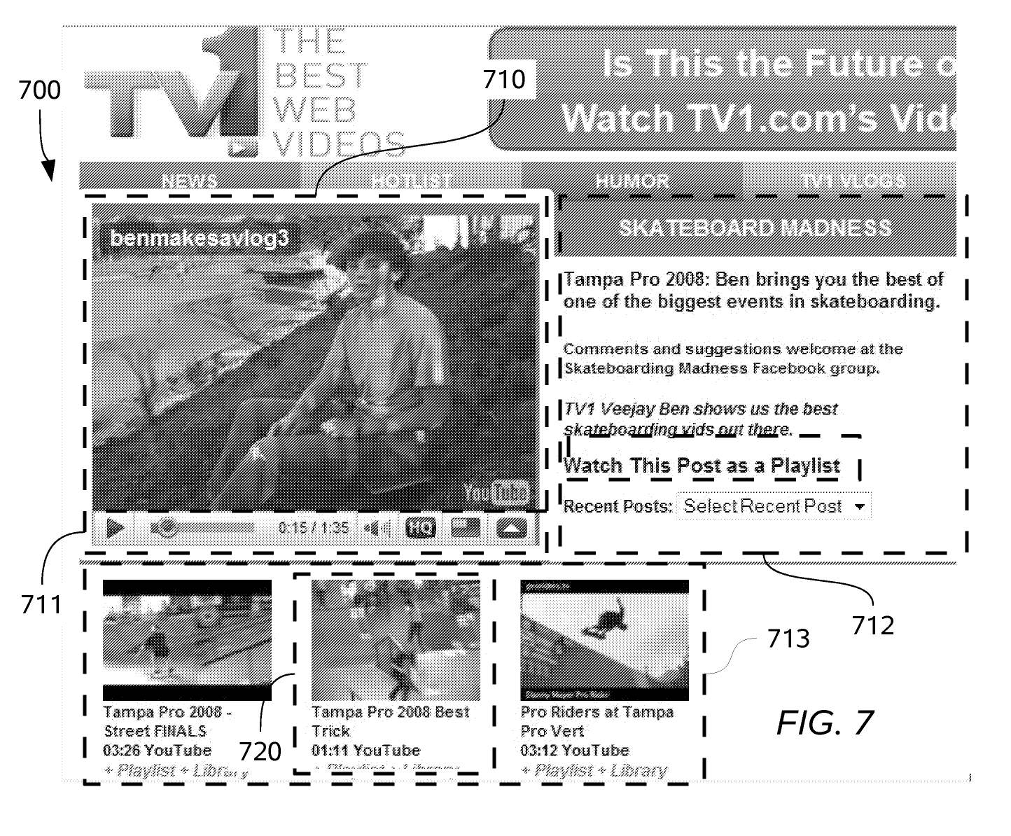

Another embodiment of the inventive system involves the end-user setting a preference of viewing selected collections of multiple videos selected by a known human agent that the agent finds of interest. This collection and the human agent's commentary thereon is referred to as a “Vlog”™, while the specific human agent is known as a “Vlogger”™. The “Vlogger” selection option would preferably be an additional column in GUI 100. The “Vloggers” might record periodic one minute long videos commenting on two to six web videos that are listed alongside their one minute videos. Thus, the “Vlogger” would be creating new video media that is accessible like other video's, being arranged in the last column 111 in the GUI 100 in FIG. 1. A “Vlogger” may be accessed by an end user through an automatic personalization script through which the end user sets a preference indicating which “Vloggers” to be included in the user's personalized page, which is GUI 100, after which the videos from those “Vloggers” are dynamically displayed on the user's personalized page. Once selecting a particular “Vlog” title in column 111, the user is next directed to the GUI 700 shown in FIG. 7.

The human agent or “Vlogger” creates subject specific “Vlog” which is a commentary on referenced videos that appear on the very same page; using select abstracting of portions of what they see. Such commentary can optionally be purely video or any combination of text or pure audio as well. Generally, the commentary would cover each of the video's the “Vlogger” has selected and made available for viewing on the system. The commentary would include selected portions of the actual video, but generally not such much as would violate the principles of fair use, along with commentary and additional textual information to allow viewers to focus on videos of interest or appreciate nuances between video of similar or the same subject. For example, commenting on or contrasting different sportsman athletic skill or teaching, or contrasting how different news organization report the same or similar events, such as to highlight media bias or spin by omitting materials or excluding other information.

FIG. 6 is an alternative and more preferred embodiment of the playlist 170 where it is displayed in a separate window after generation, without the matrix in the GUI 100 of FIG. 1. In the GUI 600 in FIG. 6, the playlist is displayed in sequential order in a single column; each entry 620 in the column representing a video the end-user has selected as described with respect to FIG. 1.

Entry 620 preferably includes a title 130, a still frame 140 from the video, and a play time 150. Further, information, such as the name of the home page 680 of the site hosting video is also included in entry 620. It may also optionally include any of the previously described information that was presented in the GUI 100 of FIG. 1, as well as additional information not listed in the GUI 100. Further there are control icons, in the form of up and down arrow buttons 621 and 622 respectively, that when activated cause an entry 620 to be moved up and down in the playlist order. In addition, the trash can icon 630 is operative when activated to delete the associated entry 620 from the playlist. The total playtime 650 for the entire play list is displayed adjacent the clock icon at the top right corner of the list. Activation of play icon or button 660 causes the list to be played in the final sequence shown in the GUI 600. GUI 600 also features an advertiser supplied video 670, which can be played in the browser window. Further, in any of the GUI's 100 and 600 just an individual video is optionally played by clicking on still frame 140 with the entry.

As various embodiments of the invention features video content selected by a human editorial process, it should be appreciated that the process would generally differ with the category of the content. As for example, news videos and humor videos would be selected through a comparable process, but each process follows specified editorial guidelines based on the category. News videos are preferably broken down by subject and are selected for their ability to integrate documentary footage with a minimum of “spin” or punditry. Comedy videos are selected from the top-viewed web video humor sites, based upon their popularity, “TV1.com”™ editorial selections, and “Out of the Blue” recommendations of lesser-known videos emailed to the editors.

Such an editorial process for humor videos might ultimately result for example a review of the four most popular humor videos from ten most popular humor sites all on one page, with the human editor then picking the four best of this group of 40. However, the other 36 videos might also be presented.

FIG. 7-12 illustrate additional preferred embodiments GUI's 700 for displaying, editing and creating playlists by the user or another human agents, such as the “Vlogger”. More specifically, FIG. 7-9 illustrates alternative views of a GUI 700 for viewing an interactive video editorial created by a human agent, i.e. the “Vlogger”.

Preferably there will be a “Vlogger” on every subject page that is accessible from the main menu shown in FIG. 1 or variants thereof, as for example with subjects will be everything from fashion to cooking to hockey and basketball and hip hop music, etc.

In FIG. 7, there is a frame 710 for viewing a video commentary, which preferably includes a sound track in which the human agent/“Vlogger” comments on a series of other videos that they believe will be of interests to visitors to the web site, all related to a specific subject under which they are indexed. Associated with the video for play in frame 710 is a playbar 711 having control icons for initiating play, controlling volume, and optionally stopping, pausing and rewinding the video, as well as switching to full screen mode, and other functions associated with the play of videos such as changing the screen size and play resolution.

As the video is played in frame 710 using the control button on in playbar 711 of the GUI 700, the viewer/user sees the commentator and then segments from the full videos that they are commenting on. Each of these video is available for viewing in its entirety using a different portion of the GUI 700. Preferably, these videos will be from a recent time period since the last posting or update by this human agent.

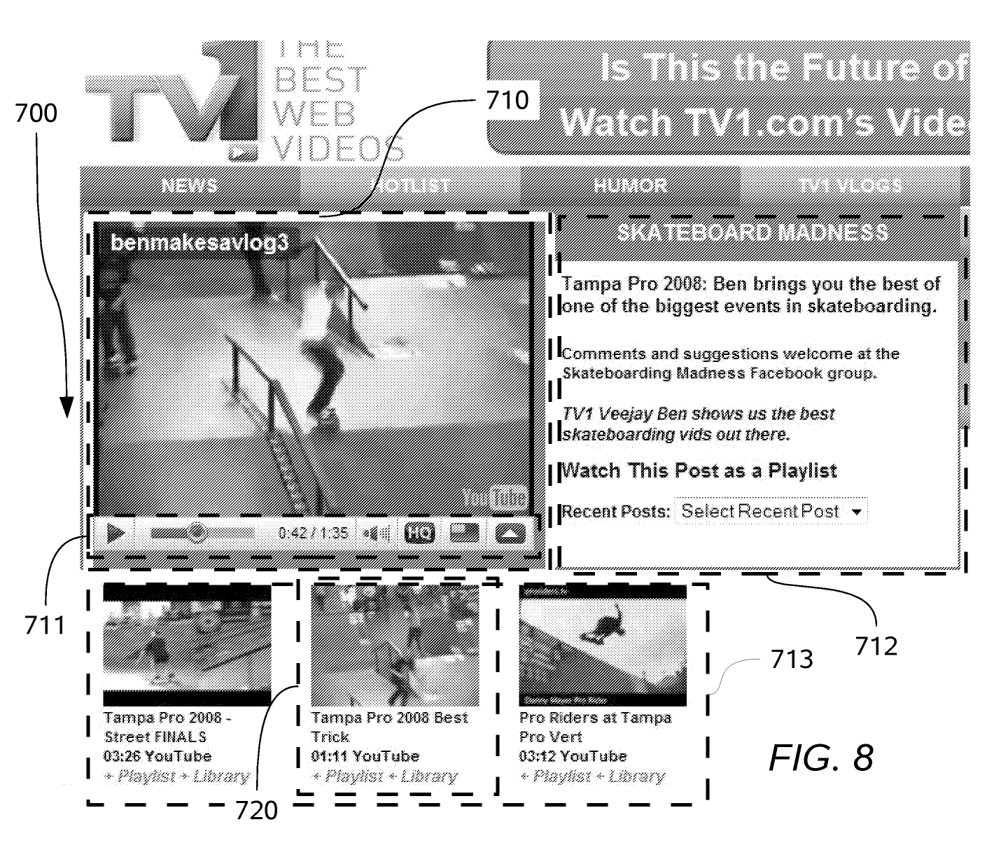

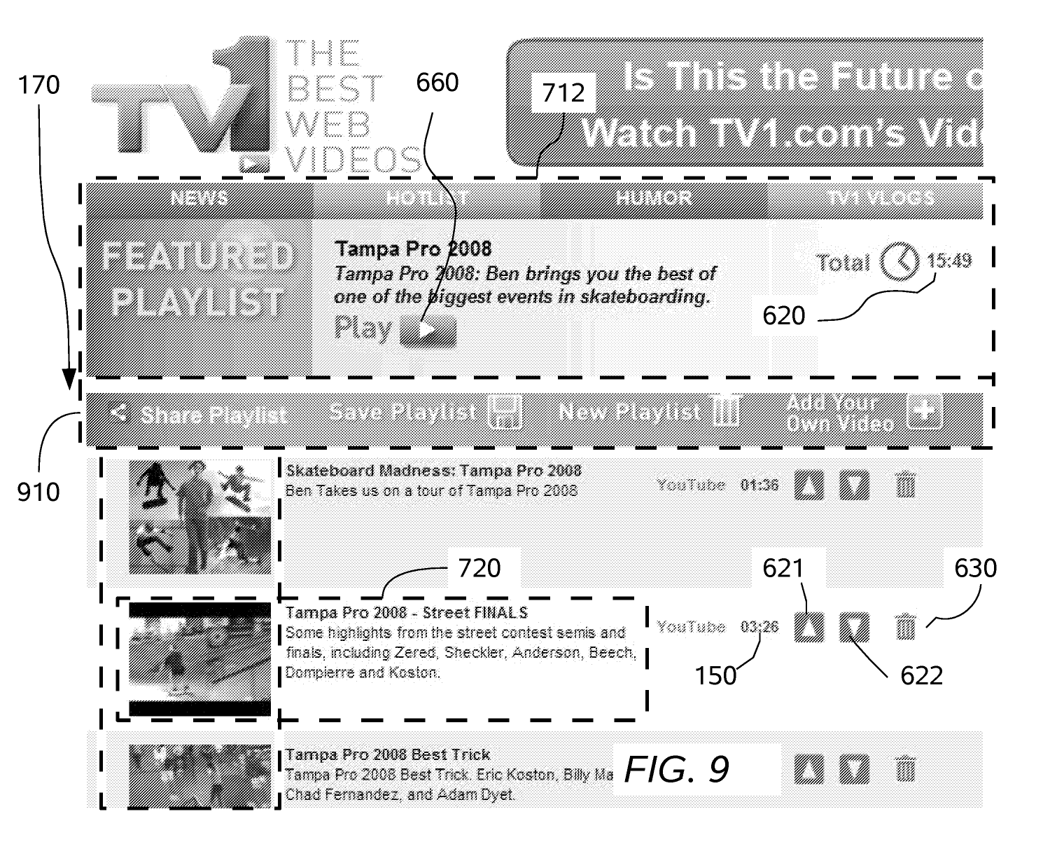

Also associated with the video for play in frame 710 is a bibliographic text box 712 that contains text to identify the name or pseudonym for the “Vlogger”, the title or subject of the “Vlog”, the date of the entry and the late, and may also include as shown a pull down menu to access older or different “Vlogs” by the same “Vlogger” or the same subject. There is also a the text control icon “Watch this Post as a Playlist” that is operative to modify how the sources videos 720 commented on by the “Vlogger” are displayed and accessible to the user, and in particular is for switching the view of GUI 700 to the playlist style GUI 170 shown in FIG. 9. In the views of GUI 700 in FIGS. 7 and 8, these source videos 720 are displayed in frame 713 as small “thumbnail” image of a representative frame of the video, along with the previously discussed bibliographic information on the video. Additional descriptive information may appear when a cursor is placed over this thumbnail view. Thus, this bibliographic information may optionally includes rating information, such as the quality rating assigned by a human reviewer, the number of times watched or played by others, a family suitability rating, the source of the video, the author or contributor, source hosting web site, playtime, title and the like. The thumbnail, text or an additional icon may be provided that is operative to cause the video selected from frame 713 to be played in its entirety in frame 710, using playbar 711. A still frame of the GUI in this mode of play is illustrated in FIG. 8, where the video title “Best Trick” is available to play through in its entirety with the “Vlogger's” commentary. It should be understood that the commentary may include portions of the original video with the sound track modified to provide a voice over by the “Vlogger”, while in the view in FIG. 8; the original sound track might be played. Alternatively, in other embodiments of the invention, the user would have other control icons to choose between commentary and the original sound track. In another optional embodiment, the “Vlogger's” written commentary for each video could appear or scroll as text in frame 712. Other icons could be available to turn on and off translations to different languages than the source video.

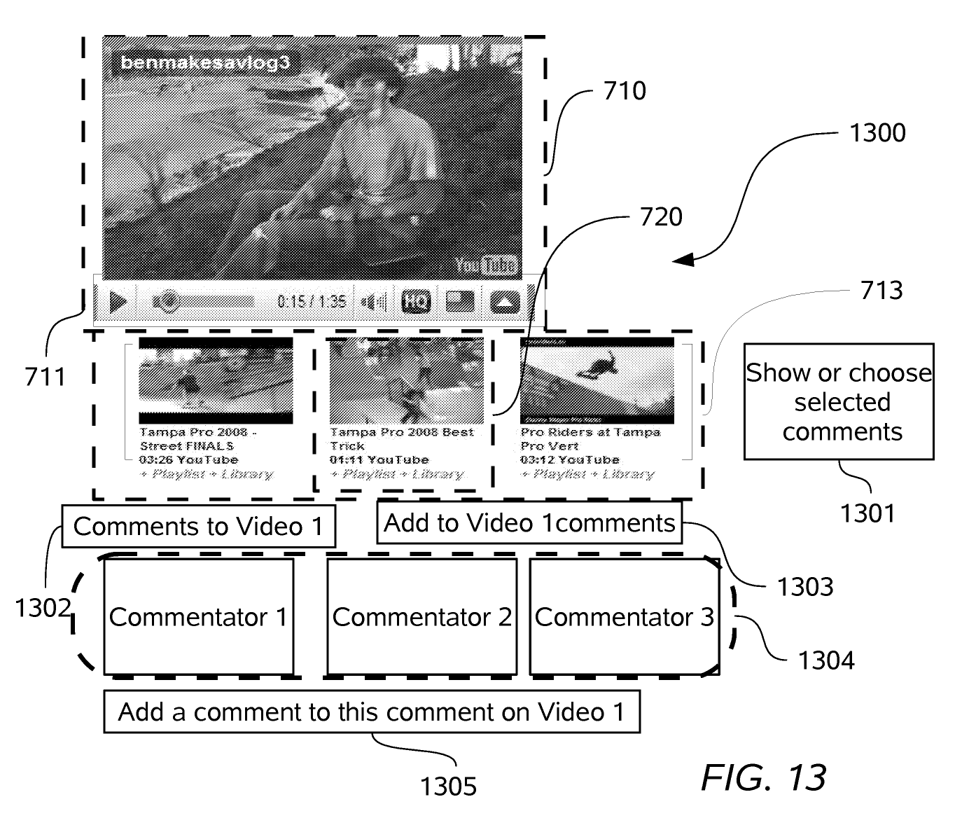

In addition to such textual comments there can be other links to source material as well as other videos, as well as commentary and links deposited by visitors who preferably register for such purpose essence what can be called a “social video network”, by using or interacting with the tool in the GUI described below with respect to FIG. 13.

The GUI 700 in FIG. 9 is comparable to that shown in FIG. 6, with frame 712 optionally supplying the same contextual information to the list as it did in FIG. 7-8, but now presents the available videos as a playlist 170. The video in frame entry 720 preferably includes a title, a still frame thumbnail from the video, and a play time 150. It may also optionally include any of the previously described information that was presented in the GUI 100 of FIG. 1, as well as additional information not listed in the GUI 100. Further there are control icons, in the form of up and down arrow buttons 621 and 622 respectively, that when activated cause an entry 720 to be moved up and down in the playlist order. In addition, the trash can icon 630 is operative when activated to delete the associated entry 720 from the playlist. The total playtime 650 for the entire play list is displayed adjacent the clock icon at the top right corner of the list. Activation of play icon or button 660 causes the list to be played in the final sequence shown in the GUI 700. GUI 700 may also optionally feature an advertiser supplied video, which can be played in the browser window of frame 710, which would also open when the user selects the video for play from the thumbnail icon or the entire playlist 660 icon.

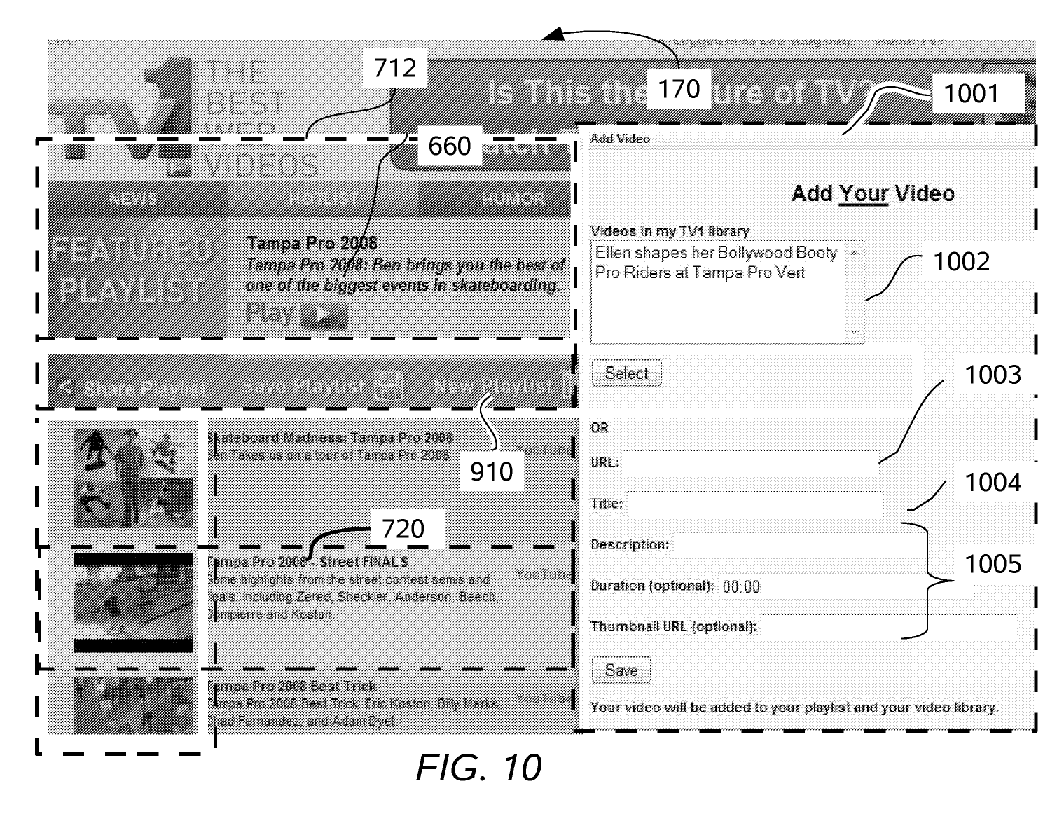

FIG. 10-12 show examples of how the playlist GUI of FIG. 9 can itself be edited, saved and shared by the user or the creator of a “Vlog”. For example, activating the icon labeled “Add Your Own Video” in frame 910 in FIG. 9 causes the display of a new GUI of playlist 170 in FIG. 10 in which a new dialog box 1001 opens. Dialog box 1001 now has user fillable fields 1002 for adding or selecting a video the user has previously stored in a reference database, either on their computer or a hosting server, which is then uploaded to the playlist when the “select” icon is activated. Alternatively, they can add a video found elsewhere on the World Wide Web or Internet by adding a URL in text field box 1003. The title of the video selected or uploaded from another URL is added in text field box 1004, and text field box 1005 accepts the addition of further video bibliographic information such as the description, duration and a thumbnail via a UR, that might ultimately be display with the icon or in the playlist. By then activating the “save” icon, the user causes the upload of the designated video to the playlist.

Hence, the “Vlogger” can use the GUI in FIG. 10 to create a new playlist which contains a video they created commenting on other videos, as well as adding the source video, those commented on, by entering their URL's in text field box 1003.

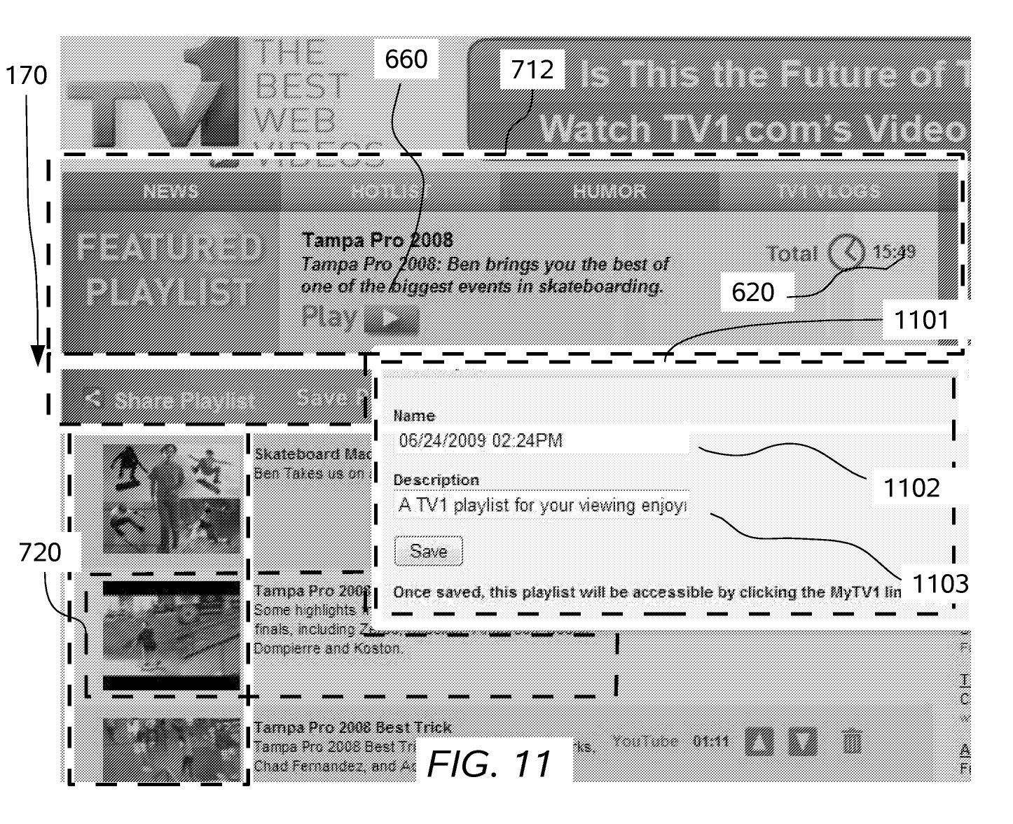

The “Vlogger” or another user can then by activating the icon labeled “Save Playlist” in frame 910 in FIG. 9 causes the display of a new GUI in FIG. 11 in which a new dialog box 1101 opens. Dialog box 1101 now has user fillable fields 1102 for adding a name for the playlist the user has created from the their own video or commentary on video, or another commentary and associated video with additional modifications, or any other playlist described elsewhere in this specification. The default name appears in this case as the date and time in filed 1102. Text field 1103 allows the user to enter a description for this play list, after which activating the “saved” icon causes the upload of the corresponding URL and play order to the host website which is later accessible to the user.

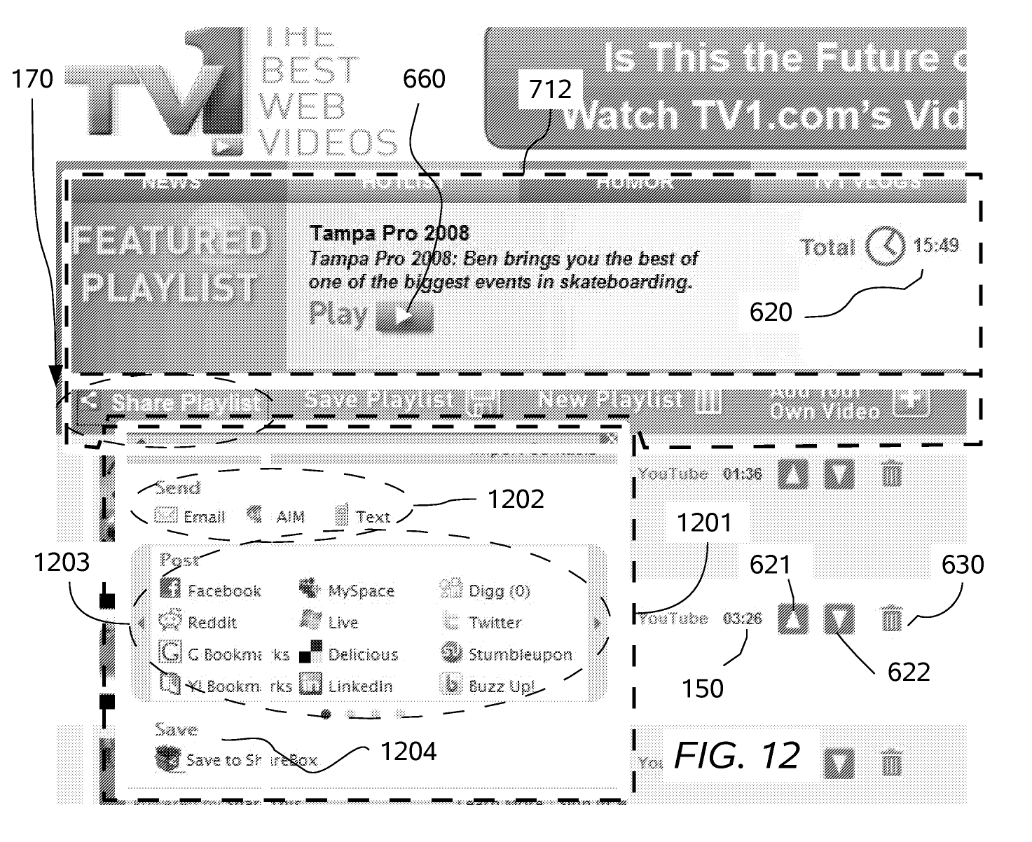

Alternatively, by activating the icon labeled “Share Playlist” in frame 910 in FIG. 9 causes the display of a new GUI in FIG. 12 in which a new dialog box 1201 opens. Dialog box 1201 now has a series of icons 1202 the activation of which initiates further dialogs for sending the playlist by e-mail, AIM or Text, such as a text message to a phone or any other form of electronic communication. Dialog box 1201 now has a series of icons 1203 the activation of which initiates access to the selected social or networking website. Alternatively by selecting the icon “SAVE” 1204 the user can upload the saved playlist to a shared web site accessible to a list of users that are preselected.

FIG. 13 is another GUI 1300 that is operative for viewing and adding commentary either to the initial “Vlog” of FIG. 7, or the source videos 720 commented on in frame 713. Thus, GUI 1300 in addition to providing the controls and functionality of GUI 700 in FIG. 7, is also operative to permit the user to view to comments previously made to a video, such as video 1 (720) in frame 1302 (shown in frames designed by 1304) by actuating the icon of frame 1302 designated “comments to Video 1”. A user or the “Vlogger” can add further comments to the comments list for video 1 or any other video in frame 713 by actuating the icon of frame 1303 designated “Add to Video 1 comments”. These icons then open up dialog boxes with text fillable fields for adding comments, and may also open dialog boxes such as 1001 in FIG. 10 to add commentary in the form of additional video, or combinations of video and text. For example, a skateboarder might comment on execution of a stunt by contributing a video of how they or a third party execute the same stunt, along with at their option text commentary or a title summarizing the gist of the video they contribute.

In other embodiments of the invention, the “Vlogger” can review the comments and then organize or edits them so only the best and most appropriate supporting comments or alternative viewpoints are shown. As for example, the “Vlogger” may take out what is inappropriate, rude, offensive or duplicative, as well as any other matter violating pre-established rules of use. Thus, in addition, in implementing the inventive system it is preferable to require authors of the video editorial commentary to the system also agree to enforceable principles before their content editorial content is hosted. It is further expected that in addition to commentators, such as the “Vlogger”, there can addition or secondary “Vloggers that form a user community will police and rate itself for such secondary content.

It should be appreciated that as videos on all manner of subjects can be found in an ever increasing number of locations on the Internet, the inventive system need not actually host them or replications thereof but rather by novel methods described herein can provides ordered and intelligent access without the need for significant server capacity, even though many users are likely to designate a customizable GUI interface.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

We claim:

1. A method of Internet video content management, comprising the steps of:
a) obtaining a plurality of URL's that provides video content,
b) viewing the video content of the URL's,
c) selecting a portion of the URL's to recommend for access by others in the form of a playlist,
d) characterizing the video content of the playlist by attributes of,
i) a name associated with the party that made the selection in the previous step,
ii) category,
iii) total play time,
e) storing the URLs of the video content and the attributes in a data structure that is computer readable.

2. A method of Internet video content management according to claim 1 further comprising the step of:
a) selecting portion of the videos associated with the selected URLs for inclusion in a video commentary thereon,
b) creating a video commentary of each of the selected URL,
c) mixing the video commentary of each selected URL adjacent to the selected portion of the video to form a new video commentary,
d) uploading the video commentary to a hosting website in associated with a new URL to provide access to the new video commentary.

3. A method of viewing video content on a connected network of servers, the method comprising the steps of:
a) defining user preferences to form a customer menu that comprises,
i) categories of content;
b) providing an end-user with a GUI in which a matrix of potential videos is presented organized by the categories of content,
c) selecting potential videos in the GUI to form a playlist for the sequential play of the selected videos,
d) initiating the play of the playlist by the end-user via a web browser on a media device in signal communication with the network, wherein said step of initiating play causes the further steps of,
e) acquiring a series of URL's to form a view script in accordance with the playlist, the view script comprising the series of URL's and playtimes for each URL, wherein the view script is operative for;
f) directing the end-user web browser to the first URL in the selected series in the play list for a first predetermined amount of time, and then
g) directing the end-user web browser to at least one subsequent URL in the view list after the previous predetermined playtime for the subsequent predetermined playtime.

4. A method of viewing video content on a connected network of servers according to claim 3 wherein at least one category of content further comprises the identity of an editor or arranger of the content.

5. A method of viewing video content on a connected network of servers according to claim 4 wherein the category of content identifies the editor or arranger of the content and includes a video that has commentary on at least some of the other videos in the category.

6. A graphic user interface (GUI) for viewing a collection of videos that comprises:
a) a matrix of potential videos organized by categories of content, wherein 2 or more choices are presented in each category portion of the matrix,
b) each element in the matrix including at least one of:
i) a sample video frame.
ii) a title,
iii) a play time,
c) wherein the GUI is operative to develop and display a playlist for the content by the selection of matrix elements using icons with the element.

7. A graphic user interface (GUI) for viewing a collection of videos according to claim 6 wherein a least one of the potential videos in said matrix includes a video that is a commentary on a plurality of videos.

8. A graphic user interface (GUI) for viewing a collection of videos according to claim 6 wherein the GUI further comprises icons operative to modify the format of the matrix.

9. A graphic user interface (GUI) for viewing a collection of videos according to claim 7 wherein the icons operative to modify the format of the matrix converts the GUI to a playlist format.

10. A graphic user interface (GUI) for viewing a collection of videos according to claim 8 wherein the GUI in a playlist format further comprises icons operative to modify at least of the order and content of the playlist.

11. A graphic user interface (GUI) for viewing a collection of videos according to claim 10 wherein the GUI in a playlist format further comprises icons operative to at least one of save the playlist and upload the playlist to a server where it is accessible to other users.

12. A graphic user interface (GUI) for viewing a collection of videos according to claim 6 that further comprises icons operative to at least one of:
a) save the playlist;
b) upload the playlist to a server where it is accessible to other users;
c) send the playlist to another user, and
d) create a playlist from a library.

13. A graphic user interface (GUI) for viewing an interactive video editorial created by a human agent, the GUI comprising:
a) a plurality of icons, each icon representing a different video available for play in a substantially complete sequence from different hosting servers by a designated URL,
b) a first viewing frame for viewing any of the videos represented by said plurality of icons,
c) a control icon operative to view a video comprising portion of each of the videos in the plurality interspersed with commentary thereof between each of the portions in the first viewing frame,
d) wherein selecting one of the plurality of icons causes the video so selected to be played in the first viewing frame.

14. A graphic user interface (GUI) for viewing a collection of videos according to claim 13 wherein the GUI further comprises at least one icon operative to modify the format of the plurality of the icons representing the different videos available for play in the substantially complete sequence from the different hosting server s.

15. A graphic user interface (GUI) for viewing a collection of videos according to claim 13 wherein the icons operative to modify the format of the plurality of the icons representing the different videos available for play converts the GUI to a playlist format.

16. A graphic user interface (GUI) for viewing a collection of videos according to claim 15 wherein the GUI in the playlist format further comprises icons operative to modify at least of the order and content of the playlist.

17. A graphic user interface (GUI) for viewing a collection of videos according to claim 14 wherein the GUI in the playlist format further comprises icons operative to at least one of save the playlist and upload the playlist to a server where it is accessible to other users.

18. A graphic user interface (GUI) for viewing a collection of videos according to claim 16 wherein the GUI in the playlist format further comprises icons operative to at least one of save the playlist and upload the playlist to a server where it is accessible to other users.

19. A graphic user interface (GUI) for viewing a collection of videos according to claim 13 wherein the GUI further comprises icons operative to create comments that are uploadable to a server hosting the content displayed by the GUI to be associated with one or more of the different videos available for play.

20. A graphic user interface (GUI) for viewing a collection of videos according to claim 19 wherein the GUI further comprises icons operative to view comments that have been uploadable to a server hosting the content displayed by the GUI that are selected for their association with a particular one of the different videos available for play.

21. A graphic user interface (GUI) for viewing a collection of videos according to claim 20 wherein the comments uploadable to the server are in the forms of videos.

22. A method of Internet video content management:
a) obtaining at least one URL that provides video content,
b) viewing the video content of the URL,
c) characterizing the video content by attributes of,
i) category,
ii) total play time,
iii) one or more times during the play that are unique to the content desired to be viewed within the video content,
d) storing the URL's of the video content and the attributes in a data structure that is computer readable.
